(19) United States
(12) Patent Application Publication
(10) Pub. No.: US 2011/0091781 A1
(43) Pub. Date: Apr. 21, 2011

(54) AUTOMATED PROCEDURE FOR EXECUTING IN-SITU FUEL CELL STACK RECONDITIONING

(75) Inventors: Daniel T. Folmsbee, Victor, NY (US); John P. Salvador, Penfield, NY (US)

(73) Assignee: GM GLOBAL TECHNOLOGY OPERATIONS, INC., Detroit, MI (US)

(21) Appl. No.: 12/580,912

(22) Filed: Oct. 16, 2009

(51) Int. Cl. H01M 8/00; H01M 8/18

(52) U.S. Cl. 429/413; 429/428; 429/452

(57) ABSTRACT

A method for reconditioning a fuel cell stack. The method includes determining whether fuel cell stack reconditioning is desired based on predetermined reconditioning triggers, determining if predetermined system constraints are met that will allow reconditioning of the fuel cell stack to occur, and determining whether previous reconditioning processes have been attempted, and if so, whether predetermine reconditioning limits have been exceeded during those attempts. The reconditioning process is initiated if one or more of the reconditioning triggers has occurred, the predetermined system constraints are met and the predetermined reconditioning limits have not been exceeded. The reconditioning process increases the humidification level of a cathode side of the fuel cell stack over the humidity level of the cathode side during normal operating conditions and waiting for cell membranes in the fuel cell stack to saturate after the humidification level of the cathode has increased.

### BACKGROUND OF THE INVENTION

1. Field of the Invention

This invention relates generally to a system and method for reconditioning a fuel cell stack and, more particularly, to a system and method for reconditioning a fuel cell stack that includes increasing the humidification level of the cathode side of the stack to hydrate the cell membranes and providing hydrogen to the anode side of the fuel cell stack at system shut down without stack loads being applied so that the hydrogen crosses the membranes to the cathode side and reacts with oxygen to reduce contaminants, where the system monitors reconditioning event triggers, reconditioning thresholds and limits and reconditioning system checks so that the reconditioning process can be provided during vehicle operation.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte there between. The anode receives hydrogen gas and the cathode receives oxygen or air. The hydrogen gas is dissociated at the anode catalyst to generate free protons and electrons. The protons pass through the electrolyte to the cathode. The protons react with the oxygen and the electrons at the cathode catalyst to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically, but not always, include finely divided catalytic particles, usually a highly active catalyst such as platinum (Pt) that is typically supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow fields are provided on the anode side of the bipolar plates that allow the anode reactant gas to flow to the respective MEA. Cathode gas flow fields are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

The membrane within a fuel cell needs to have sufficient water content so that the ionic resistance across the membrane is low enough to effectively conduct protons. Membrane humidification may come from the stack water by-product or external humidification. The flow of reactants through the flow channels of the stack has a drying effect on the cell membranes, most noticeably at an inlet of the reactant flow. However, the accumulation of water droplets within the flow channels could prevent reactants from flowing therethrough, and may cause the cell to fail because of low reactant gas flow, thus affecting stack stability. The accumulation of water in the reactant gas flow channels, as well as within the gas diffusion layer (GDL), is particularly troublesome at low stack output loads.

As mentioned above, water is generated as a by-product of the stack operation. Therefore, the cathode exhaust gas from the stack will typically include water vapor and liquid water. It is known in the art to use a water vapor transfer (WVT) unit to capture some of the water in the cathode exhaust gas, and use the water to humidify the cathode input airflow. Water in the cathode exhaust gas at one side of the water transfer elements, such as membranes, is absorbed by the water transfer elements and transferred to the cathode air stream at the other side of the water transfer elements.

In a fuel cell system, there are a number of mechanisms that cause permanent loss of stack performance, such as loss of catalyst activity, catalyst support corrosion and pinhole formation in the cell membranes. However, there are other mechanisms that can cause stack voltage losses that are substantially reversible, such as the cell membranes drying out, catalyst oxide formation, and build-up of contaminants on both the anode and cathode side of the stack. Therefore, there is a need in the art to remove the oxide formations and the build-up of contaminants, as well as to rehydrate the cell membranes, to recover losses in cell voltage in a fuel cell stack.

Wet operation, that is, operation with a high amount of humidification, is desirable for system humidification, performance and contaminant removal. However, there are various reasons to operate a fuel cell stack with a lower amount of humidification, also known as dry conditions. For example, wet operation can lead to fuel cell stability problems due to water build up, and could also cause anode starvation resulting in carbon corrosion. In addition, wet operation can be problematic in freeze conditions due to liquid water freezing at various locations in the fuel cell stack. Therefore, there is a need in the art for systems that have been optimized for non-wet operating conditions.

### SUMMARY OF THE INVENTION

In accordance with the teachings of the present invention, a method for reconditioning a fuel cell stack is disclosed. The method includes determining whether fuel cell stack reconditioning is desired based on predetermined reconditioning triggers, determining if predetermined system constraints are met that will allow reconditioning of the fuel cell stack to occur, and determining whether previous reconditioning processes have been attempted, and if so, whether predetermine reconditioning limits have been exceeded during those attempts. The reconditioning process is initiated if one or more of the reconditioning triggers has occurred, the predetermined system constraints are met and the predetermined reconditioning limits have not been exceeded. The reconditioning process increases the humidification level of a cathode side of the fuel cell stack over the humidity level of the cathode side during normal operating conditions and waiting for cell membranes in the fuel cell stack to saturate after the humidification level of the cathode has increased.

Additional features of the present invention will become apparent from the following description and appended claims, taken in conjunction with the accompanying drawings.

### BRIEF DESCRIPTION OF THE DRAWINGS

FIG. 1 is a schematic block diagram of a fuel cell system;

FIG. 2 is a flow chart diagram showing a method for removing oxidation and contaminant build up in a fuel cell stack through a reconditioning process;

FIG. 3 is a flow chart diagram showing various criteria to enter the stack reconditioning process;

FIG. 4 is a flow chart diagram showing a process for monitoring a procedure for determining when to exit the reconditioning process; and

FIG. 5 is a flow chart diagram showing a process to determine whether the reconditioning process was successful.

### DETAILED DESCRIPTION OF THE EMBODIMENTS

The following discussion of the embodiments of the invention directed to a system and method for reconditioning and assessing the reconditioning of a fuel cell stack so as to recover stack voltage is merely exemplary in nature, and is in no way intended to limit the invention or its applications or uses.

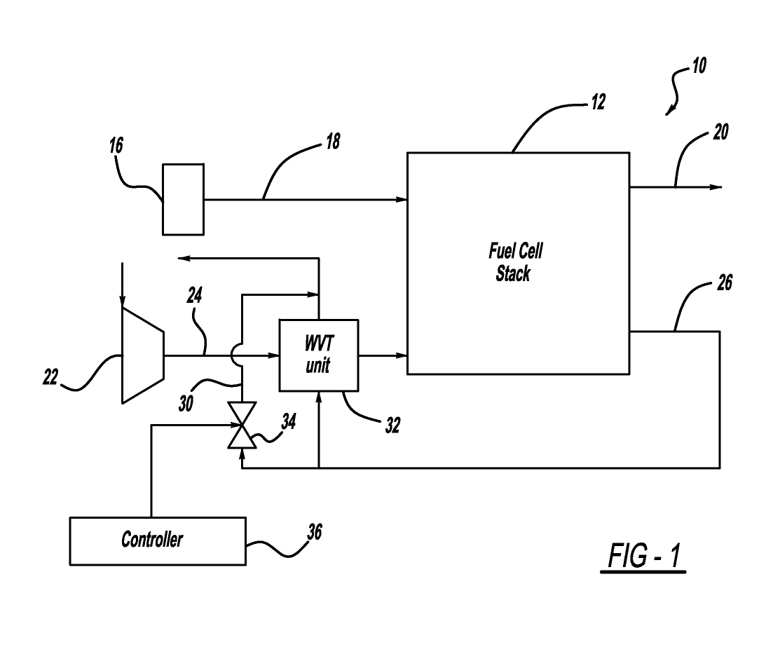

FIG. 1 is a schematic block diagram of a fuel cell system 10 including a fuel cell stack 12. The fuel cell stack 12 receives hydrogen from a hydrogen source 16 on anode input line 18 and provides an anode exhaust gas on line 20. A compressor 22 provides airflow to the cathode side of the fuel cell stack 12 on cathode input line 14 through a water vapor transfer (WVT) unit 32 that humidifies the cathode input air. The WVT unit 32 is employed in this embodiment as a non-limiting example, where other types of humidification devices may be applicable for humidifying the cathode inlet air, such as enthalpy wheels, evaporators, etc. A cathode exhaust gas is output from the stack 12 on a cathode exhaust gas line 26. The exhaust gas line 26 directs the cathode exhaust to the WVT unit 32 to provide the humidity to humidify the cathode input air. A by-pass line 30 is provided around the WVT unit 32 to direct some or all of the cathode exhaust gas around the WVT unit 32 consistent with the discussion herein. In an alternate embodiment, the by-pass line can be an inlet by-pass. A by-pass valve 34 is provided in the by-pass line 30 and is controlled to selectively redirect the cathode exhaust gas through or around the WVT unit 32 to provide the desired amount of humidity to the cathode input air.

A controller 36 controls whether the by-pass valve 34 is opened or closed, and how much the by-pass valve 34 is opened. By controlling the by-pass valve 34, the controller 36 is able to determine how much cathode exhaust gas is directed through the WVT unit 32, and thus how much water from the cathode exhaust gas will be used to humidify the cathode input air.

Cathode outlet humidification is a function of stack operating conditions, including cathode and anode inlet relative humidity, cathode and anode stoichiometry, pressure and temperature. During reconditioning, discussed below, it is desirable to increase the humidification level of the membranes. This is typically accomplished by increasing the cathode outlet relative humidity. In this embodiment, the by-pass valve 34 is controlled during stack reconditioning to increase the humidification level of the cathode inlet air. The stack operating condition set-points will then be manipulated to further increase the cathode outlet relative humidity to the set-point, as is known in the art. Examples include reducing the stack temperature or reducing the cathode stoichiometry.

The fuel cell stack 12 may be operated relatively dry, such as with a cathode inlet and exhaust relative humidity that is less than 100%. Such dry stack operation over prolonged periods of time could lead to the drying-out of components in the stack 12, such as the cell membranes and the MEA catalyst layers. Drying out of the stack 12 is more likely under low power operation when the amount of water produced by the fuel cell stack 12 is low, but is more noticeable under high power. In addition, operation under low power and high cell voltages leads to a higher rate of oxide formation on the catalyst, particularly when a precious metal catalyst is used.

As will be discussed below, the present invention provides stack conditioning to remove contaminants from within the stack 12, such as sulfates and chlorides, that affect stack performance. During stack reconditioning, the fuel cell stack 12 is operated under wet conditions at semi-regular intervals. By operating the stack relatively wet, various ions and other molecules will go into solution within the stack 12 and be better able to be driven out by water flow through the reactant gas flow channels. Such wet conditions, for example, may be in excess of 110% relative humidity at high current densities, although other percentages of relative humidity could be used. The fuel cell system is shut down while maintaining these wet conditions. Immediately after the fuel cell system 10 is shut down, the cathode side catalyst is blanketed with hydrogen and a mixture of other gases, such as nitrogen and water vapor. This procedure is described in more detail below.

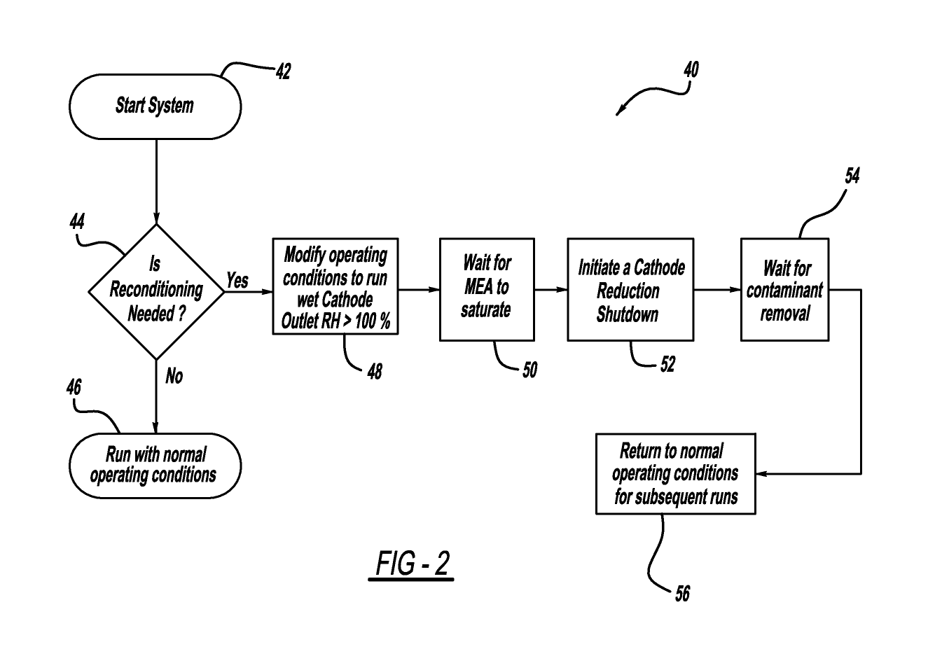

FIG. 2 is a flow diagram 40 showing steps for reconditioning the fuel cell stack 12, thereby enabling recovery of the voltage of the fuel cell stack 12. A system start is the first step at box 42. The controller 36 determines whether reconditioning of the fuel cell stack 12 is needed at decision diamond 44. The present invention contemplates any suitable algorithm or device that can detect the affects from stack contaminants that may require stack reconditioning, such as low voltages, low humidity levels, low stack power, etc. If the controller 36 determines that reconditioning of the fuel cell stack 12 is not needed at the decision diamond 44, then the controller 36 does not enable the reconditioning procedure and the fuel cell system 10 operates under normal operating conditions at box 46.

If, however, the controller 36 determines that reconditioning of the fuel cell stack 12 is needed at the decision diamond 44, then the procedure for reconditioning the stack 12 is triggered. The controls and calibrations necessary to perform the reconditioning procedure are embedded in the software of the controller 36. The controller 36 modifies the operating conditions such that the cathode exhaust gas on the line 26 is operated under wetter conditions at box 48 than would occur under normal operating conditions. An example of such wet conditions is a cathode exhaust gas relative humidity on the line 26 that is in excess of 100% relative humidity, depending on the velocities of anode and cathode gases. If the gas velocity is low, normal outlet relative humidity on the line 26 may be maintained. However, it will be readily apparent to those skilled in the art that wet conditions that are of a different outlet relative humidity and varying gas velocities may be used.

Next, the controller 36 waits for the cell MEAs to saturate to a desired relative humidity level at box 50. Liquid water flooding the fuel cell stack during saturation at box 50 on either the anode or the cathode side can be managed by actively controlling bleed, drain, and other system valves, or can be managed by increasing cathode stoichiometry. One example of avoiding flooding of the stack is to operate the stack at a higher current density, thereby utilizing higher cathode and anode velocities. However, one skilled in the art will recognize that there are other ways to prevent flooding.

By way of example, the amount of time necessary to saturate the cell MEAs to the desired humidity level may be a period of time in excess of 20 minutes at a stack current density in the range of 0.4-1 A/cm². Lower current densities can also be effective; however, they may require longer run times than those at high current density. Those having skill in the art will readily recognize that a different period of time and a different current density range will achieve the desired saturation level. Thus, this example is not intended to limit the scope of the invention in any way.

Once the cell MEAs have saturated to the desired humidity level at the box 50, the controller 36 initiates a cathode reduction upon system shut down at box 52. Cathode reduction requires that hydrogen be used to takeover and blanket the cathode side of the fuel cell stack 12. Any dry-out purges that the system would normally undergo upon shut down are not used during this procedure. By maintaining excess hydrogen in the anode side of the stack 12 upon system shut down, the hydrogen is able to cross the membranes by means of permeation to the cathode side, by direct injection, or a combination thereof, to consume available oxygen. By consuming oxygen on the cathode side of the stack 12 using hydrogen, various contaminants are reduced in the cathode side, such as those that may be bonded to platinum sites in the cathode catalyst. It is important to refrain from applying loads to the stack 12 that would accelerate the oxygen consumption during this step of the procedure. Thus, the process described so far includes first saturating the MEAs in the fuel cells in the stack 12 by humidifying the cathode inlet air above normal humidity levels, and then maintaining that saturation level to system shut down at which time hydrogen is introduced to the anode side of the fuel cell stack 12 under no load conditions to consume oxygen on the cathode side. Of course, there are limitations as to how wet the fuel cell stack 12 can be after system shut down under certain operating conditions, such as freeze conditions.

After the cathode side has been adequately blanketed with hydrogen at the box 52, the controller 36 waits for a period of time to allow for contaminant removal at box 54. By way of example, and in no way intended to limit the scope of the invention, the amount of time allowed for contaminant removal could be twenty minutes. Additional soak time may be beneficial, as more water vapor will condense when the system cools down, which will then be useful for removal of a greater fraction of the contaminants. If the required amount of time is not met prior to a system start at box 56, the benefit may not be fully realized, and the procedure may need to be repeated. When the fuel cell system 10 is restarted at box 56 after a successful reconditioning, it should function under its normal operating conditions. In the instance of an unsuccessful reconditioning, the controller will take appropriate steps, as described herein.

The above procedure enhances the ability of the fuel cell MEAs to react the fuel and oxidant because (1) the higher fraction of liquid water enables any soluble contaminates to wash off, (2) the higher level of membrane electrode saturation increases the proton conductivity of the membrane and electrode, (3) the reduction in voltage under wet conditions leads to the reduction in the surface coverage of sulfate (HS0₄⁻)-like poisoning species which then get washed off during subsequent operation, and (4) the reduction of surface oxides, such as platinum oxide (PtO) and platinum hydroxide (PtOH), which expose more of the precious metal sites.

Thus, the fuel cell stack 12 reconditioning process will provide a cell voltage performance increase by reducing the voltage losses associated with membrane resistance and catalyst layer performance. Testing has revealed that this benefit could be as large as 50 mV per cell. This increase is sustainable for hundreds of hours and can be repeated for a similar level of recovery. As a result of this increase, stack life will increase resulting in a longer service life for the fuel cell stack 12. Regular intervals of this procedure will result in a higher level of maximum performance and greater system efficiency. This procedure could also serve to re-humidify any cathode water re-humidification device, such as the WVT unit 32.

A more detailed discussion of entering, exiting and determining if the reconditioning was successful is discussed below, and is applicable for a reconditioning process that is performed while the vehicle is in operation, instead of a reconditioning process that is performed at a service center. More particularly, as will be discussed below, the algorithms for operating the reconditioning process include an algorithm to trigger the reconditioning process, an algorithm to protect the system and the vehicle operator from any adverse side effects from the modified conditions caused by the reconditioning process, an algorithm to determine if the system is sufficiently humidified, an algorithm to determine which type of shut-down to perform, and an algorithm to determine if the reconditioning process was successful.

The reconditioning process uses modified operating conditions that are not optimized for normal operation. Therefore, it is desirable to only perform the recondition process periodically. This could be based on calendar time, time on load, vehicle trips, voltage degradation, etc. Each algorithm referred to above has advantages and disadvantages, but it is important to perform the reconditioning process periodically to maximize over-all efficiency, performance and/or durability impacts that could result from reconditioning. Further, it is necessary to protect the system from adverse side effects from the modified conditions. The wet operation that is allowed during the reconditioning process could lead to anode starvation. This is mitigated through an aggressive bleed strategy. However, if starvation is detected, the algorithm can be aborted and normal operation can be resumed. The wet operation also puts the system at risk for difficulty in freeze events. Therefore, the reconditioning process is not executed or is aborted if a risk for a freeze event is detected.

Additionally, the wet operation could affect the vehicle performance due to power limitations on aggressive load profiles. If performance is limited, the reconditioning process may be aborted and returned to normal operating conditions and performance. A critical component of the reconditioning process is to sufficiently humidify the stack 12. In order for the humidification to occur consistently during customer use, the operating conditions must be modified such that this humidification occurs under common load profiles, such as the EPA city cycle. It is also important for the system to know when it has reached a sufficient level of humidification. This can be done using a water buffer model (WBM) to estimate the amount of water present in the membrane and diffusion media of the stack 12. As described above, it is desirable to perform a cathode reduction shut-down after the MEA is sufficiently wet. When the driver initiates a shut-down, there can be logic using the previously described WBM criteria to determine which type of shut-down to perform. If it is determined that the MEAs are sufficiently humidified, a cathode reduction shut-down can be performed. If the previous run did not sufficiently humidify the MEAs, a normal shut-down procedure could be initiated. This is important because the cathode reduction shut down results in some positive performance gains, and it does not execute other desired functions, such as a purge for freeze.

Finally, it is necessary to determine if all of the conditions of the shut-down have been met. If the system has been sufficiently humidified, executed a proper cathode reduction shut-down and soaked a sufficient amount of time, all the criteria discussed above have been met and the reconditioning process is a success. If not, the reconditioning process will be attempted again until it is either successful or it exceeds a predetermined number of attempts.

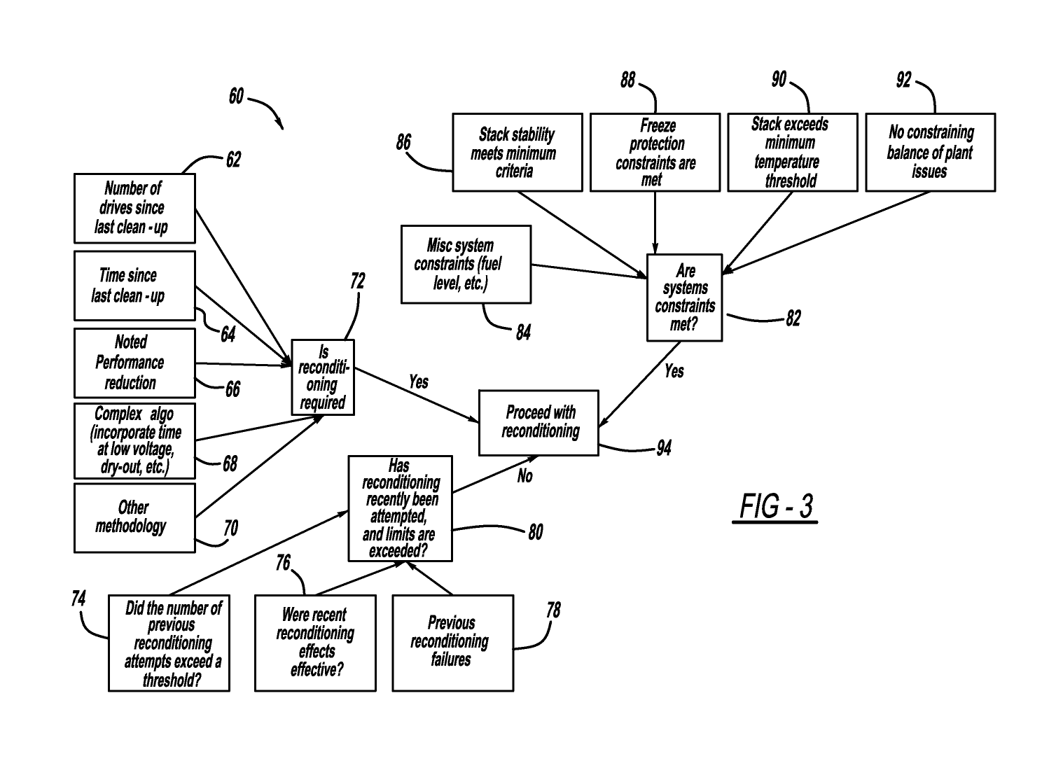

FIG. 3 is a flow chart diagram 60 including some of the algorithm discussed above, including when to enter the reconditioning process and whether certain system constraints prevent the reconditioning process. The flowchart diagram 60 shows a number of possible reconditioning algorithm event triggers, including the number of drives since the last reconditioning process at box 62. The algorithm can set a reconditioning event trigger if the vehicle has been driven a certain number of times based on experimental data as to when reconditioning would be the most beneficial. Further, another possible trigger is the time since the last reconditioning process at box 64. Regardless of the number of times the vehicle has been driven, it may be desirable to perform the reconditioning process based on time alone. The reconditioning process may also be triggered based on performance at box 66, where the stack polarization curve or other stack information, such as cell voltage, can be monitored to determine when reconditioning may be required because of low stack performance. Further, complex algorithms at box 68 can be used to monitor various fuel cell systems and stack conditions, such as low voltage conditions, dry-out conditions of stack membrane, high frequency resistance (HFR) conditions of fuel cells, etc. to determine when the reconditioning process is desirable. Also, any other suitable methodology at box 70 for entering the reconditioning process can be monitored. If any of these triggers occurs, then the algorithm may set a recondition required flag at box 72.

Because the reconditioning process may not be ideal for optimized system operation, certain thresholds and limits can be incorporated to prevent the reconditioning process if it is triggered if certain conditions have occurred. This is shown by box 74 which decides if the number of previous recondition attempts exceed a predetermined threshold. In other words, if there have been too many reconditioning attempts in the recent past, it may not be desirable to continue attempting to recondition the stack 12 if that threshold has been met. Also, the algorithm determines if recent reconditioning attempts were effective at box 76. Further, the algorithm determines the number of previous reconditioning processes that have failed at box 78, and if, that number exceeds a predetermined threshold, the reconditioning process can be prevented. If any of the limits have been exceeded at the boxes 74, 76 and 78, then the algorithm may prevent the reconditioning process that may be triggered at the decision diamond 72 from happening at box 80.

As also discussed above, various system conditions need to be monitored to make sure that the reconditioning process isn't detrimental to the system or the user. For this operation, various system checks are monitored at box 82, such as miscellaneous system constraints at box 84. For example, the algorithm may determine that the fuel level is too low for a reconditioning process to be performed. Further, the algorithm determines if the stack stability meets certain minimum stability criteria at box 86. If the stack stability as a result of various conditions, such as flow channel flooding, minimum cell voltage, etc., is occurring, it may not be desirable to perform the reconditioning process. Further, because the reconditioning process operates the stack 12 with high humidity levels, it may not be desirable to run the reconditioning process because of freeze conditions at box 88 as a result of ambient conditions. Further, the actual stack temperature provided by the stack cooling fluid may be below a minimum temperature threshold where reconditioning would not be desirable at box 90, which could cause the stack membranes to operate too wet. Another system check has to do with monitoring the operation of various sensors that would determine if the reconditioning process should be performed or was being performed effectively, represented here as no constraining balance of plant issues at box 92.

If a reconditioning process is triggered at the box 72, and all of the system checks are satisfied at the box 82 and no reconditioning limits or thresholds have been exceeded at the box 80, then the reconditioning process is performed at box 94. depending on the characteristics of a given system, this list of necessary constraints could be expanded or reduced.

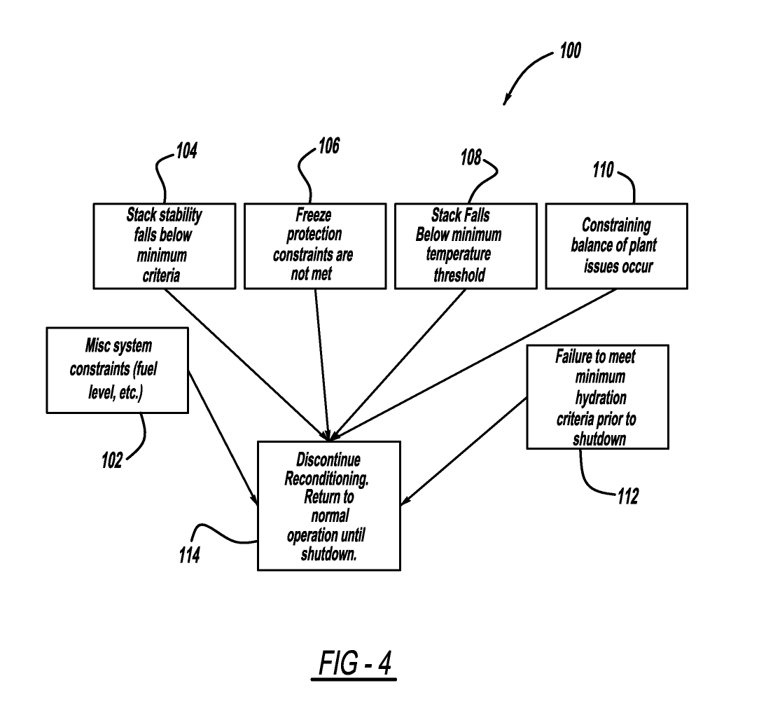

If the reconditioning process proceeds at the box 94, various system conditions and criteria are monitored during the reconditioning process to determine whether it should be aborted because it will have to great of an impact on system performance, safety, damage, etc. FIG. 4 is a flow chart diagram 100 that discusses these events that could lead to ending the reconditioning procedure as it is occurring. The criteria include the same basic criteria for the system checks at the boxes 84, 86, 88, 90 and 92, but may have different thresholds and levels for aborting the reconditioning process. Particularly, box 102 determines miscellaneous system constraints, such as fuel level, box 104 determines whether stack stability falls below a minimum criteria, box 106 determines whether freeze protection constraints are not met, box 108 determines whether the stack falls below a minimum temperature threshold and box 110 determines whether constraining balance of plant issues have occurred. Further, box 112 determines whether there is a failure to meet minimum hydration criteria prior to shut-down for the part of the reconditioning process that includes the shut-down procedure. If any of the thresholds or level are exceeded at the boxes 102, 104, 106, 108, 110 and 112, then the algorithm discontinues the reconditioning at box 114 and returns to a normal operation until shut-down.

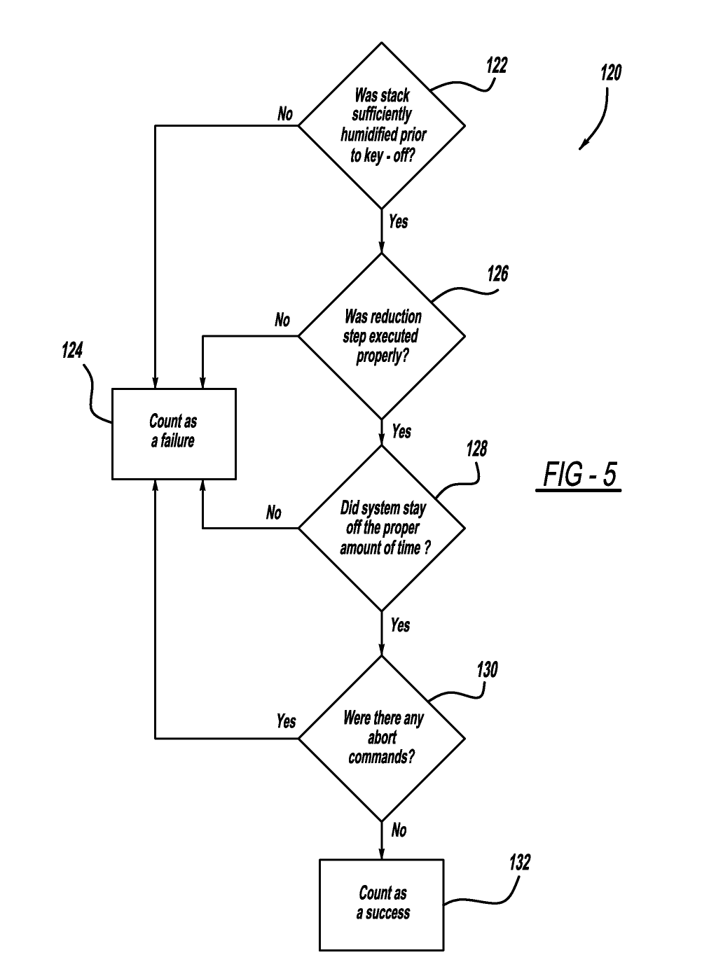

FIG. 5 is a flow chart diagram 120 showing a process for determining whether a reconditioning process was successful, which can be used by the analysis at the box 80. At decision diamond 122, the algorithm determines whether the stack 12 was sufficiently humidified prior to key-off, and if not, the reconditioning process is counted as a failure at box 124. Any suitable technique can be used to determine whether the stack 12 was sufficiently humidified, such as models, sensors, estimations, etc. If the stack 12 was sufficiently humidified prior to key-off at the decision diamond 122, the algorithm then determines if the reduction step executed properly at decision diamond 126, and if not, the reconditioning process is counted as a failure at the box 124. If the reduction step was executed properly at the decision diamond 126, then the algorithm determines whether the system stayed off the proper amount of time after shut down from the reconditioning process at decision diamond 128, and if not, the reconditioning process is counted as a failure at the box 124. If the system did stay off the proper amount of time at the decision diamond 128, the algorithm determines whether there were any abort commands during the reconditioning process at decision diamond 130, and if so, the reconditioning process is counted as a failure at the box 124. Otherwise, if the reconditioning procedure meets all of the requirements, then it is counted as a success at box 132.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for reconditioning a fuel cell stack, said method comprising:
determining whether fuel cell stack reconditioning is required based on a plurality of reconditioning triggers;
determining if predetermined system constraints are met that will allow reconditioning of the fuel cell stack to occur;
determining whether previous reconditioning processes have been attempted, and if so, whether predetermined reconditioning limits have been exceeded;
determining to proceed with the fuel cell stack reconditioning if one or more of the reconditioning triggers has occurred, the predetermined system constraints are met and the predetermined reconditioning limits have not been exceeded; and
performing the fuel cell stack reconditioning by increasing the humidification level of a cathode side of the fuel cell stack over the humidity level of the cathode side during normal operating conditions and waiting for cell membranes in the fuel cell stack too saturate after the humidification level of the cathode side has increased.

2. The method according to claim 1 wherein determining whether the fuel cell stack reconditioning is required includes one or more of determining whether the number of vehicle drives since a last fuel cell stack reconditioning has exceeded a predetermined number, determining whether a time since the last reconditioning has been exceeded, determining whether fuel cell system performance is below predetermined limits and determining whether a low stack voltage or stack membrane dry-out is occurring.

3. The method according to claim 1 wherein determining whether if system constraints are met includes one or more of determining whether the fuel level of the vehicle is below a predetermined fuel level, determining whether stack stability meets a minimum criteria, determining whether predetermined freeze protection constraints are met, determining whether fuel cell stack temperature is less than a predetermined minimum threshold and determining if there are any constraining balance of plant issues.

4. The method according to claim 1 wherein determining whether previous reconditioning processes have been attempted includes determining if the number of previous reconditioning processes exceeded a threshold, determining whether previous reconditioning processes were effective and determining whether previous reconditioning processes were failures.

5. The method according to claim 4 wherein determining whether previous reconditioning processes were effective includes determining whether the fuel cell stack was sufficiently humidified prior to key-off, and if not, determining that the reconditioning was a failure, determining whether a reduction step executed properly, and if not, determining that the reconditioning was a failure, determining if the system stayed off a desired amount of time, and if not, count the reconditioning as a failure, and determining that there are no reconditioning abort commands, and if so, counting the reconditioning as a failure, otherwise counting the reconditioning as a success.

6. The method according to claim 1 further comprising terminating the reconditioning if certain predetermined criteria are met.

7. The method according to claim 6 wherein the predetermined criteria for terminating the reconditioning include a low fuel level, stack stability falls below a minimum predetermined level, freeze protection constraints are not met, the temperature of the fuel cell stack falls below a predetermined minimum temperature, balance of plant issues are occurring and the fuel cell stack has failed to meet minimum hydration criteria prior to a shut-down.

8. The method according to claim 1 wherein performing the reconditioning includes providing a hydrogen take-over of the cathode side during a shut-down of the fuel cell stack and waiting for contaminates to be removed as a result of the increased humidification level and the hydrogen take-over.

9. The method according to claim 1 wherein performing the reconditioning includes performing the reconditioning during operation of the fuel cell vehicle while driving.

10. A method for reconditioning a fuel cell stack, said method comprising:
determining whether fuel cell stack reconditioning is required based on a plurality of reconditioning triggers that include one or more of determining whether the number of vehicle drives since a last fuel cell stack reconditioning has exceeded a predetermined number, determining whether a time since the last reconditioning has been exceeded, determining whether fuel cell system performance is below predetermined limits and determining whether a low stack voltage or stack membrane dry-out is occurring;
determining if predetermined system constraints are met that will allow reconditioning of the fuel cell stack to occur that include determining whether the fuel level of the vehicle is below a predetermined fuel level, determining whether stack stability meets a minimum criteria, determining whether predetermined freeze protection constraints are met, determining whether fuel cell stack temperature is less than a predetermined minimum threshold and determining if there are any constraining balance of plant issues;
determining whether previous reconditioning processes have been attempted, and if so, whether predetermined reconditioning limits have been exceeded that include determining whether the number of vehicle drives since a last fuel cell stack reconditioning has exceeded a predetermined number, determining whether a time since the last reconditioning has been exceeded, determining whether fuel cell system performance is below predetermined limits and determining whether a low stack voltage or stack membrane dry-out is occurring;
determining to proceed with the fuel cell stack reconditioning if one or more of the reconditioning triggers has occurred, the predetermined system constraints are met and the predetermined reconditioning limits have not been exceeded; and
performing the fuel cell stack reconditioning by increasing the humidification level of a cathode side of the fuel cell stack over the humidity level of the cathode side during normal operating conditions and waiting for cell membranes in the fuel cell stack too saturate after the humidification level of the cathode side has increased.

11. The method according to claim 10 wherein determining whether previous reconditioning processes were effective includes determining whether the fuel cell stack was sufficiently humidified prior to key-off, and if not, determining that the reconditioning was a failure, determining whether a reduction step executed properly, and if not, determining that the reconditioning was a failure, determining if the system stayed off a desired amount of time, and if not, count the reconditioning as a failure, and determining that there are no reconditioning abort commands, and if so, counting the reconditioning as a failure, otherwise counting the reconditioning as a success.

12. The method according to claim 10 further comprising terminating the reconditioning if certain predetermined criteria are met.

13. The method according to claim 12 wherein the predetermined criteria for terminating the reconditioning include a low fuel level, stack stability falls below a minimum predetermined level, freeze protection constraints are not met, the temperature of the fuel cell stack falls below a predetermined minimum temperature, balance of plant issues are occurring and the fuel cell stack has failed to meet minimum hydration criteria prior to a shut-down.

14. The method according to claim 10 wherein performing the reconditioning includes providing a hydrogen take-over of the cathode side during a shut-down of the fuel cell stack and waiting for contaminates to be removed as a result of the increased humidification level and the hydrogen take-over.

15. The method according to claim 10 wherein performing the reconditioning includes performing the reconditioning during operation of the fuel cell vehicle while driving.

16. A system for reconditioning a fuel cell stack, said system comprising:
means for determining whether fuel cell stack reconditioning is required based on the plurality of the reconditioning triggers;
means for determining if predetermined system constraints are met that will allow reconditioning of the fuel cell stack to occur;
means for determining whether previous reconditioning processes have been attempted, and if so, whether predetermined reconditioning limits have been exceeded;
means for determining to proceed with the fuel cell stack reconditioning if one or more of the reconditioning triggers has occurred, the predetermined system constraints are met and the predetermined reconditioning limits have not been exceeded; and
means for performing the fuel cell stack reconditioning by increasing the humidification level of a cathode side of the fuel cell stack over the humidity level of the cathode sides during normal operating conditions and waiting for cell membranes in the fuel cell stack to saturate after the humidification level of the cathode side has increased.

17. The system according to claim 16 wherein the means for determining whether the fuel cell stack reconditioning is required determines whether the number of vehicle drives since a last fuel cell stack reconditioning has exceeded a predetermined number, determining whether a time since the last reconditioning has been exceeded, determining whether fuel cell system performance is below predetermined limits and determining whether a low stack voltage or stack membrane dry-out is occurring.

18. The system according to claim 16 wherein the means for determining whether if system constraints are met determines whether the fuel level of the vehicle is below a predetermined fuel level, determining whether stack stability meets a minimum criteria, determining whether predetermined freeze protection constraints are met, determining whether fuel cell stack temperature is less than a predetermined minimum threshold and determining if there are any constraining balance of plant issues.

19. The system according to claim 16 wherein the means for determining whether previous reconditioning processes have been attempted determines if the number of previous reconditioning processes exceeded a threshold, determining whether previous reconditioning processes were effective and determining whether previous reconditioning processes were failures.

20. The system according to claim 19 wherein the means for determining whether previous reconditioning processes have been attempted determines whether the fuel cell stack was sufficiently humidified prior to key-off, and if not, determining that the reconditioning was a failure, determining whether a reduction step executed properly, and if not, determining that the reconditioning was a failure, determining if the system stayed off a desired amount of time, and if not, count the reconditioning as a failure, and determining that there is no reconditioning abort commands, and if so, counting the reconditioning as a failure, otherwise counting the reconditioning as a success.
